(19) United States
(12) Patent Application Publication
(10) Pub. No.: US 2007/0194586 A1
(43) Pub. Date: Aug. 23, 2007

(54) Slide-out room and components used in the manufacture of the same

(76) Inventor: Stewart E. Gardner, Bristol, IN (US)

Correspondence Address: R. TRACY CRUMP, P.O. BOX 604, 32790 DUNN ROAD, NEW CARLISLE, IN, 46552, US

(21) Appl. No.: 11/606,406

(22) Filed: Nov. 29, 2006

Related U.S. Application Data
(60) Provisional application No. 60/740,930, filed on Nov. 30, 2005.

(51) Int. Cl. B60P 3/34

(52) U.S. Cl. 296/26.13

(57) ABSTRACT

The slide-out room is constructed from monocoque laminate wall panels interconnected by an end wall sub-frame. The end wall sub-frame is constructed from unique main extrusion members that are interconnected using key-locked miter joints. Each main extrusion member has a generally Z-shaped cross section, which allows the members to be joined using two joint keys fitted into spaced parallel key channels formed in the main extrusion members. The end wall sub frame also includes secondary extrusion members welded to the main extrusion members and interconnected using a lap joint. The secondary extrusion members have legs that are spaced from the legs of the main extrusion so that the monocoque panels can be fitted and secured between the legs to and from the side walls, ceiling and floor of the slide-out room. A monocoque panel is bonded directly to the outside of the end wall sub-frame to form the slide-out room end wall.

This invention relates to slide-out rooms of recreational vehicles and an extrusion used in the manufacture of slide-out rooms.

### BACKGROUND OF THE INVENTION

Slide-out rooms extend and retract from the main body of recreational vehicles (RVs) and other types of manufactured housing to provide additional living space. Typically slide out rooms are mounted on tracks, rails or other supports and are actuated by linkage and screw drives. The design and construction of conventional slide-out rooms present several present practical problems in RV and other manufactured housing applications.

Because slide-out rooms are extended and retracted from the main body of the RV, the slide-out rooms must be constructed to minimize weight, without compromising structural integrity. Reducing the weight of slide out rooms allows manufacturers to build larger slide-out rooms without increasing the power and size of the actuating mechanisms. To reduce weight and simplify construction, monocoque laminate wall panels are often used in slide-out rooms. Monocoque laminate wall panels have an internal metal skeleton and an insulated core sandwiched between outer skins. Monocoque laminate wall panels are light weight, thin and sturdy and have finished skin surfaces making them ideal for slide-out room construction. While reducing weight and simplifying construction, monocoque laminate panels must still be secured to a metal framework, which interconnects and supports the panels to form the side and end walls, ceiling and floor. This metal framework is constructed of welded metal channel and tubing, which must be dimensioned to accommodate the dimensions of the panels. Reducing the weight and simplifying the construction by eliminating the need for an extensive framework even with monocoque wall panels would provide a great improvement for slide-out rooms.

In addition, the conventional design and construction of slide-out rooms have been a source of sealing problems when the slide-out room is retracted into the RV interior. To prevent weather exposure, metal flanges are mounted around the periphery of the end wall of the slide out room, which abuts against the side wall of the RV when the slide-out room is retracted into the RV interior. Gaskets fixed to the back of the seal flanges contact the sidewall of the RV around the slide out opening to hermetically seal any gaps between the slide-out room and the RV sidewall. Typcially, the seal flanges are simply angle channel fastened with screws to the edge of the slide-out end wall. If the slide-out room is not constructed to be perfectly square or is not retracted uniformly into the RV interior, the gasket on the flange also will not seat properly. More importantly, these seal flanges fastened to the slide-out end wall are not sturdy enough to provide a proper seal over extended use. Consequently, a slide-out room with a sturdy integrated peripheral flange is desirable.

### SUMMARY OF THE INVENTION

The slide-out room embodying the present invention is constructed from monocoque laminate wall panels interconnected by an end wall sub-frame. The end wall sub-frame is constructed from an unique main extrusion members that are interconnected using key-locked miter joints. Each main extrusion member has a generally Z-shaped cross section, which allows the members to be joined using two joint keys fitted into spaced parallel key channels formed in the main extrusion members. The end wall sub frame also includes secondary extrusion members welded to the main extrusions members and interconnected using a lap joint. The secondary extrusion members have legs that are spaced from the legs of the main extrusion so that the monocoque panels can be fitted and secured between the legs to form the side walls, ceiling and floor of the slide-out room. A monocoque panel is bonded directly to the outside of the end wall sub-frame to form the slide-out room end wall.

The slide-out room embodying this invention eliminates the need for an extensive framework upon which the room is constructed. The unique configuration of the main extrusion members allows the end wall sub-frame to be assembled using key-locked miter joints, which ensure a sturdy and rigid structure upon which the slide-out room is built. The design and construction of the end wall sub-frame using the unique configuration of the main extrusion member in conjunction with a conventional angle extrusion allows the end wall sub-frame to be readily adapted for use with monocoque panels of different widths. The end wall sub-frame also eliminates the need for seal flanges fastened around the periphery of the slide-out end wall. The backs of the main extrusion members are oversized and extend peripherally beyond the side walls, ceiling and floor of the slide-out room to act as a seal flange.

Theses and other advantages of the present invention will become apparent from the following description of an embodiment of the invention with reference to the accompanying drawings.

### BRIEF DESCRIPTION OF THE DRAWINGS

The drawings illustrate an embodiment of the present invention, in which:

FIG. 1 is a perspective view of an embodiment of the slide out room of this invention;

FIG. 2 is an exploded partial plan view of the end wall sub-frame corner illustrating the interconnection of two main extrusion members of the end wall sub-frame;

FIG. 3 is an exploded partial perspective view of the end wall sub-frame corner illustrating the interconnect of two main extrusion members of the end wall sub-frame;

FIG. 4 is an exploded partial plan view of the end wall sub-frame corner illustrating the placement and connection of two secondary extrusion members to the two main extrusion members;

FIG. 5 is a partial plan view of the end wall sub-frame corner illustrating the placement and connection of two secondary extrusion members to the two main extrusion members;

FIG. 6 is a sectional view of a main extrusion member and secondary extrusion members of the end wall sub-frame;

FIG. 7 is an exploded perspective view of the end wall sub-frame and the end wall monocoque panel;

FIG. 8 is a perspective view of the end wall sub-frame and the end wall monocoque panel bonded to the sub-frame;

FIG. 9 is a perspective view of the slide out room of FIG. 1 shown extended from the sidewall of a partially shown recreational vehicle;

FIG. 10 is a perspective view of the slide out room of FIG. 1 shown retracted into the sidewall of a partially shown recreational vehicle; and

FIG. 11 is a partial top sectional view of the slide-out room of FIG. 1 in its retracted position with the slide-out end wall abutted against the vehicle sidewall.

### DESCRIPTION OF THE PREFERRED EMBODIMENT

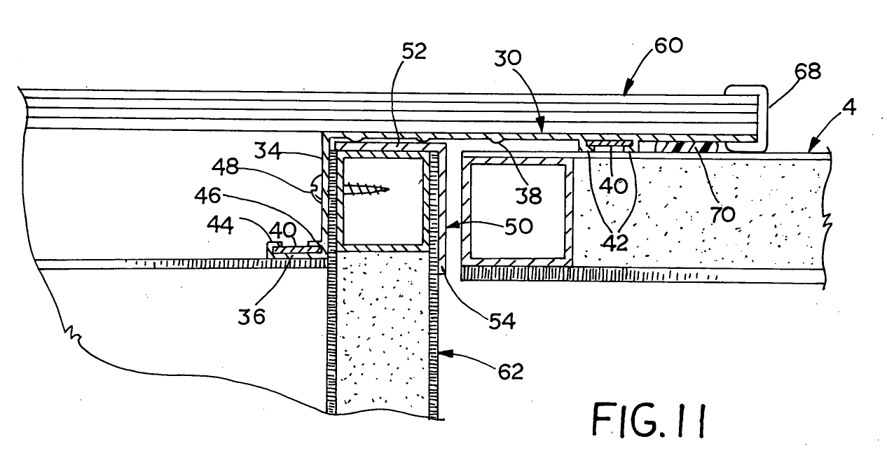

Referring now to the drawings, the slide-out room embodying the teaching of this invention is generally designated as reference numeral 10. Slide-out room 10 is constructed from monocoque laminate wall panels interconnected by an end wall sub-frame 20. Monocoque laminate wall panels are well known in the recreational vehicle industry. Monocoque wall panels are light weight and can be constructed in any desirable width, size or configuration. As best illustrated in FIG. 11, the monocoque wall panels have an internal tubular aluminum skeleton and an insulated core sandwiched between outer skins. The internal skeleton provides structural integrity to the panel. Typically, the insulation core is a polyester/styrene copolymer and the outer skins are a gel-coat, such as Filon, bonded to lauan plywood.

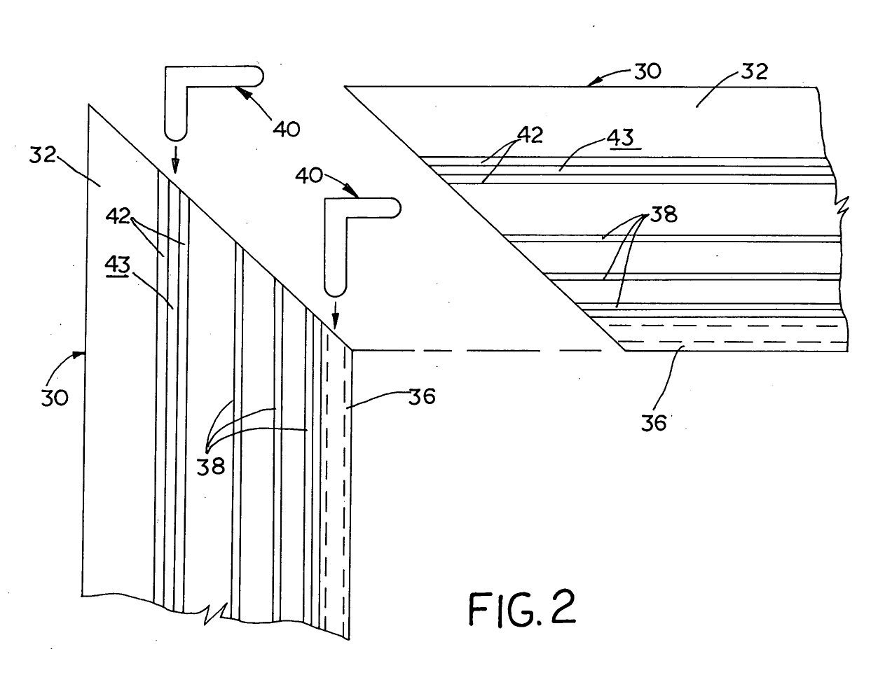

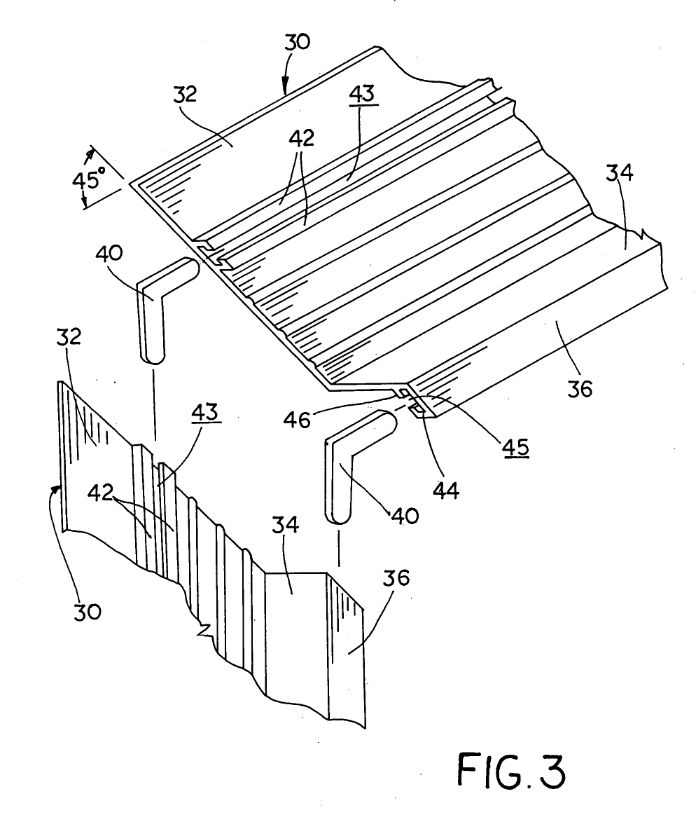

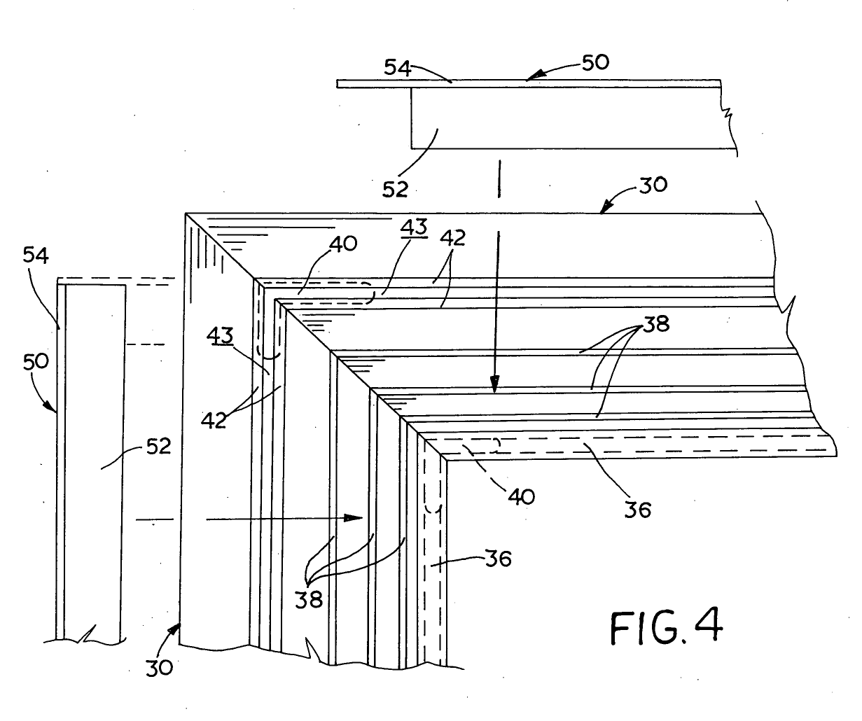

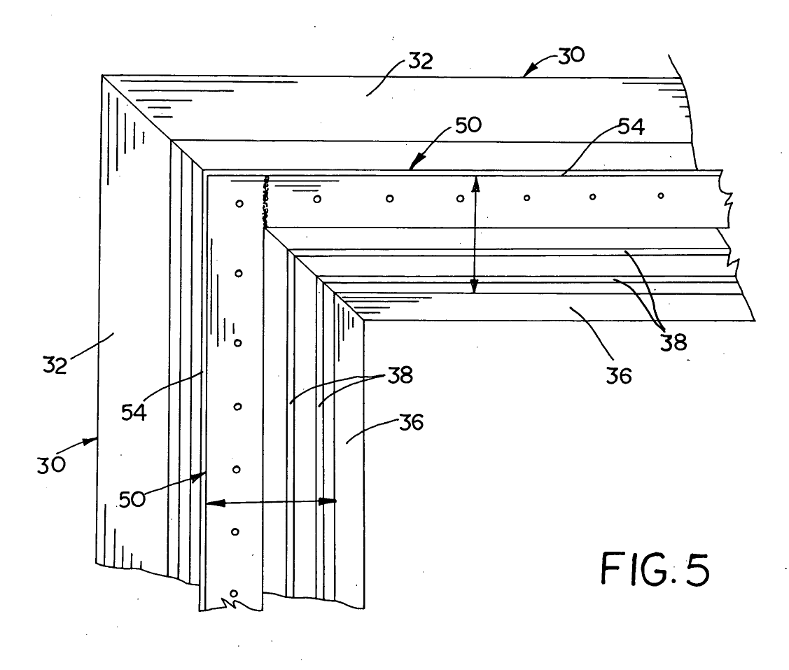

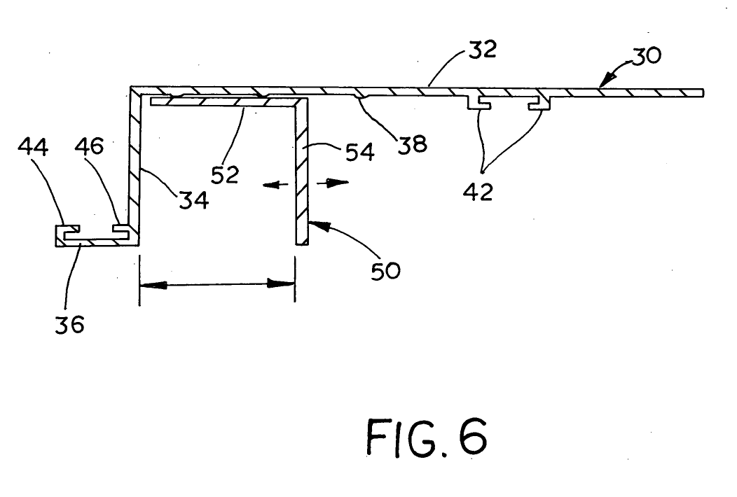

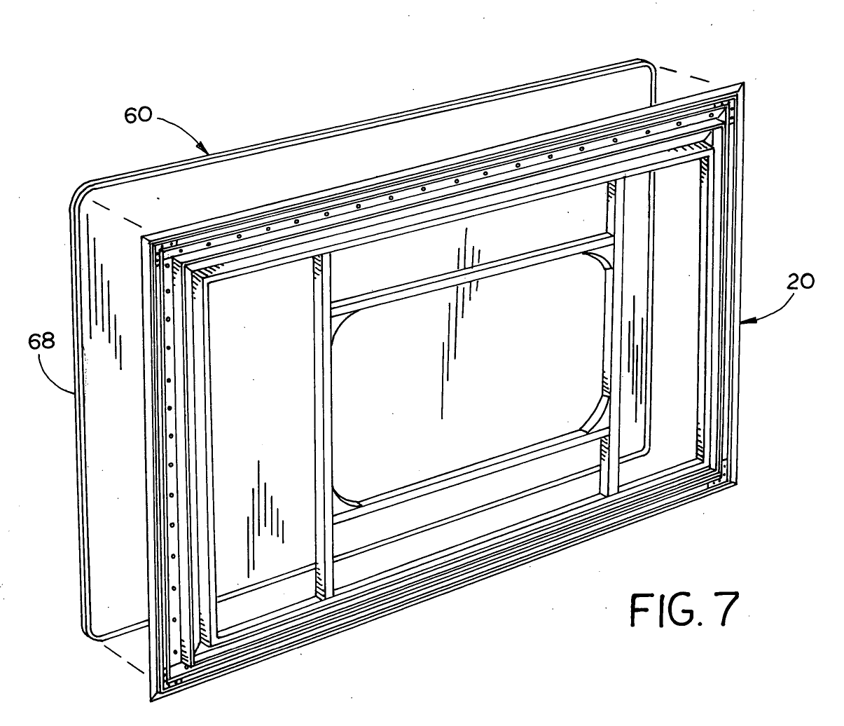

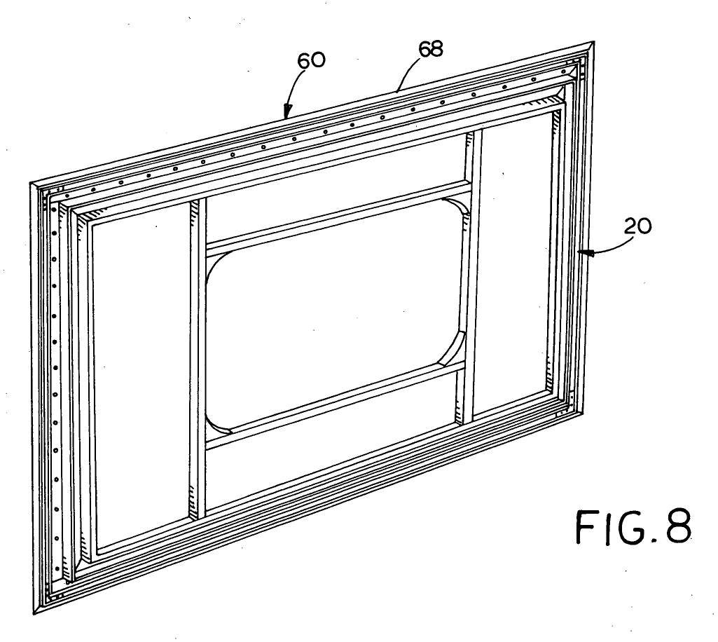

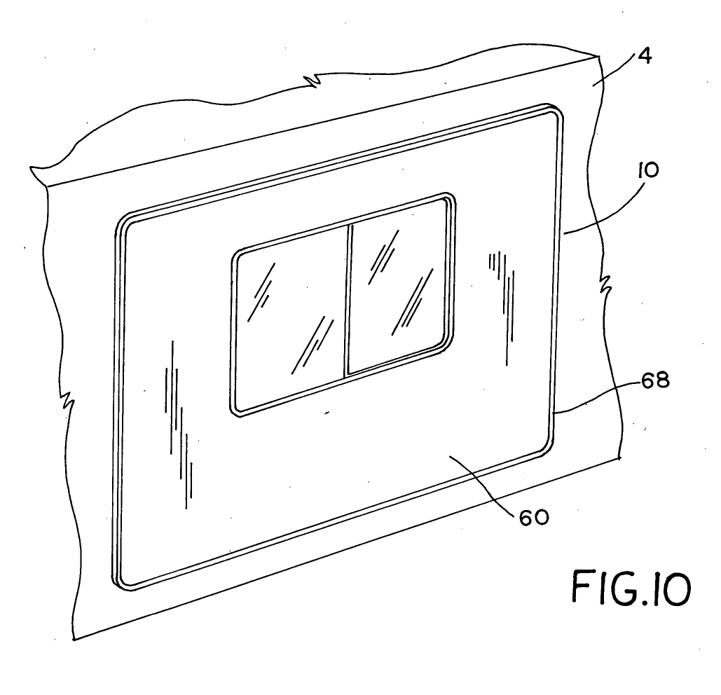

As shown in FIGS. 2-11, end wall sub-frame 20 is constructed from four main extrusion members 30 interconnected end to end using key-locked miter joints. Each main extrusion member 30 is formed to has a flat longitudinal back 32, a leg 34 extending perpendicularly from one edge of the back, and a foot 36 extending perpendicularly from one edge of the leg, giving the main extrusion members a Z-shaped cross section. It should be noted that back 32 and foot 36 lie in parallel planes with leg 34 extending perpendicularly between the back and foot. Main extrusion members 30 also include a plurality of longitudinal ribs 38 (three shown), which reinforce the back and provide structural integrity to the main extrusion member. A pair of opposed L-shaped flanges 42 extend from the inner face of back 32 and form a key channel 43. Similarly, the bottom face of foot 36 has an L-shaped flange 44 and the outer face of leg 34 has a flange 46 that form a second key channel 45. Main extrusion members 30 are cut to length for the desired dimensions of the outer end wall with their ends cut at 45 degree angles for the miter joints. Flat L-shaped joint keys 40 are inserted into key channels 43 and 45, which align and secure the ends of adjacent main extrusion members 30. Once secured using joint keys 40, the corner seams can be tack welded to permanently interconnect main extrusion members 30.

Sub frame 20 also includes four secondary extrusion members 50 welded to backs 32 of the main extrusion members 30 and interconnected using a lap joint. Each secondary extrusion members 50 is a conventional angle channel having an L-shaped cross section with two legs 52 and 54. One leg 52 of each secondary extrusion member 50 is welded flat to back 32 of each main extrusion member 30 so that leg 54 is spaced from and parallel to leg 34 of main extrusion member 30 to allow a monocoque panel to be seated and secured between legs 34 and 54. It should be noted that secondary extrusion members 50 are inset from the peripheral edge of backs 32 of the main extrusion members 30, which can be positioned to accommodate panels of varying widths.

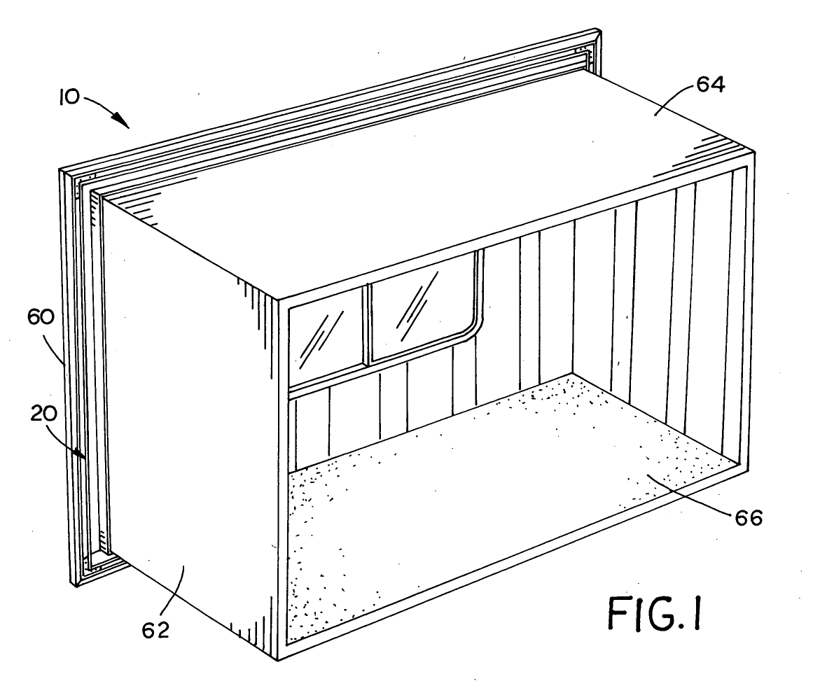

As shown, end wall sub-frame 20 may be reinforced with additional cross members and braces as need to accommodate windows and other features. Once end wall sub-frame 20 is constructed to the desired dimensions, the assembly of slide-out room 10 is completed by mounting the monocoque laminate wall panels 60, 62, 64, 66 to sub-frame 20. As shown in FIGS. 11, side wall panels 62, ceiling panel 64 and floor panels 66 are seated between legs 34 and 54 of extrusion members 30 and 50. Screws 48 extend through legs 34 to secure the monocoque panels to sub-frame 20. As shown in FIGS. 1, 8 and 11, backs 32 of main extrusion members 30 are oversized and the side wall panels 62, ceiling panel 64 and floor panel 66 are inset from the outer edge of backs 32. End wall panel 60 is bonded directly to sub-frame 20. An adhesive is used to secure end wall panel 60 to the outside of end wall sub-frame 20 with the panel bonded directly to and covering backs 32 of main extrusion members 30. Ideally, an edge molding 68 is mounted around the periphery of end wall panel 60. As best shown in FIG. 11, a gasket strip 70 is mounted to the inner face of the exposed inner face of backs 32 of the main extrusion members 30.

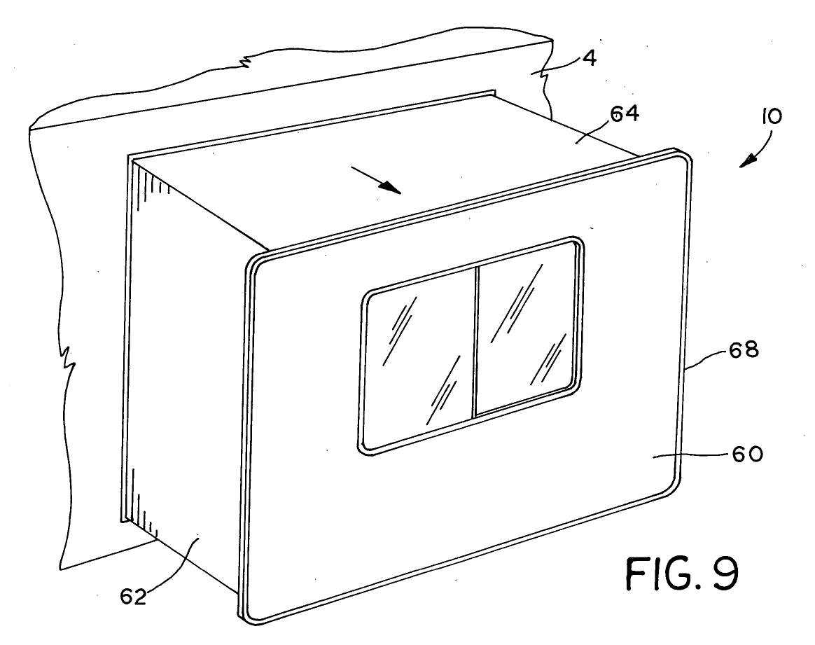

FIGS. 9-11 illustrate slide-out room 10 in its extended and retracted positions respectively. Slide-out room 10 is reciprocally mounted within the slide-out opening in the RV sidewall 4 and actuated for movement between its extended and retracted positions by conventional mechanisms, which are not shown but well known in the industry. When slide-out room 10 is retracted into the RV interior, the inner face of backs 32 of the main extrusion members 30 abut against RV sidewall 4 so that gasket strip 70 creates a hermetic seal around the slide-out opening.

One skilled in the art will note that the slide-out room embodying this invention has several advantages over design and construction of conventional slide-out rooms. The end wall sub-frame eliminates the need for an extensive framework, thereby reducing the weight and cost of the room while simplifying its construction. The end wall sub-frame supports and interconnects all of the monocoque wall panels, which form the slide-out room. The side wall, ceiling and floor panels are easily fastened to the end wall sub-frame. Bonding the end wall panel to the outside of the end wall sub-frame produces a rigid exterior end wall.

The configuration of the main extrusion members, allows the end wall sub-frame to be assembled using key-locked miter joints, which ensure a sturdy and rigid structure upon which the slide-out room is built. The corner joints of the main extrusion members are secured using two joint keys fitted into spaced parallel key channels formed in the main extrusion members. One key channel is formed on the back of the extrusion and other key channel is formed on the parallel foot of the main extrusion member. Welding the secondary extrusion members to the main extrusion members using lap joints further reinforces the structure of the end wall sub-frame. The design and construction of the end wall sub-frame using the unique configuration of the main extrusion member in conjunction with a conventional angle extrusion allows the construction of the end wall sub-frame to be readily adapted for use with monocoque panels of different widths. Since the secondary extrusion can be mounted to the main extrusion member to allow any width of monocoque panel to be fitted between the legs of the main and secondary extrusions, the construction design of the end wall sub-frame eliminates the need for specialized extrusion for each width of monocoque panel.

The end wall sub-frame also eliminates the need for seal flanges fastened around the periphery of the slide-out end wall. Since the backs of the main extrusion members are oversized and the side wall, ceiling and floor panels are inset from the edge of the backs when fastened to the end wall sub-frame, the backs of the main extrusion members act as a seal flange or abutment plate around the periphery of the slide-out end wall. A seal gasket is mounted directly to the inside face of the backs of the main extrusion members. Because the main extrusion members are an integral part of the end wall sub-frame, the backs of the main extrusion members are sturdy, which eliminates the need for a seal flange fastened around the slide-out end wall. Using the oversized backs of the main extrusions to acts as seal plates ensure a proper seal between the slide-out room end wall and the RV side wall.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A slide-out room used in a recreational vehicle where the vehicle includes a sidewall defining a vehicle interior and having an opening therein, the room being retractable through an opening in one of the vehicle exterior walls for movement between a retracted position where the room is retracted into the vehicle interior and an extended position where the room extends from the vehicle interior,
the room comprising:
an end wall sub-frame, the sub-frame includes a plurality of first extrusion members joined end to end and a plurality of second extrusion members mounted end to end over the first extrusion members, each of the plurality of first extrusion members having a flat back, a leg extending from the back, and a foot extending from the leg parallel to and spaced from the back, the back of each of the first extrusion members has a first key channel defined therein, the foot of each of the first extrusion members has a second key channel defined therein, the sub-frame also including a plurality of first joint keys interconnecting adjacent first extrusion members and a plurality of second joint keys interconnecting adjacent first extrusion members, each of the first joint keys has a leg seated within the first key channel of one first extrusion member and another leg seated within the first key channel of the adjacent first extrusion member, each of the second joint keys has a leg seated within the second key channel of one first extrusion member and another leg seated within the second key channel of the adjacent first extrusion member, the sub-frame also including a plurality of second extrusion members, each of the plurality of second extrusion members mounted longitudinal to one of the plurality of first extrusion members and having a leg spaced from and parallel to the leg of one of the first extrusion members;
a first monocoque panel bonded directly to the end wall sub-frame and overlying the backs of the main extrusion members; and
a plurality of second monocoque panels secured perpendicularly to the sub-frame with each of the plurality of second monocoque panels fastened between the leg of one of the plurality of first extrusion members and the leg of one of the plurality of second extrusion members.

2. The slide-out room of claim 1 wherein the back of each of the plurality of first extrusion members abuts against the RV sidewall when the slide-out room is in its retracted position.
